(19) United States
(12) Patent Application Publication
(10) Pub. No.: US 2015/0354762 A1
(43) Pub. Date: Dec. 10, 2015

(54) LIGHTED GARTER

(71) Applicant: Pebet LLC, Sparta, NJ (US)

(72) Inventor: Philipp Elliott, Sparta, NJ (US)

(21) Appl. No.: 14/733,072

(22) Filed: Jun. 8, 2015

Related U.S. Application Data
(60) Provisional application No. 62/008,637, filed on Jun. 6, 2014.

(51) Int. Cl. F21L 4/02; F21V 33/00; F21V 23/04; A41F 11/16

(52) U.S. Cl. CPC F21L 4/02; A41F 11/16; F21V 33/0008; F21V 23/0407; F21Y 2113/005

(57) ABSTRACT

A garter includes a body having an elastic band surrounded by a textile material. A plurality of light-emitting diode (LED) lights are electrically connected to one another and circumferentially disposed about an outside portion of the body between the elastic band and the textile material. A power source is electrically connected to the plurality of lights and disposed along an inside portion of the body between the textile material and the elastic band. The power source includes a power switch engagable by a user of the garter to turn on the power source and switch the lighted garter from an off condition to an on or lighted condition. During the on condition of the garter, each of the plurality of LED lights flash between a plurality of colors at a predetermined time interval.

### RELATED APPLICATION

The subject application claims priority to U.S. Provisional Application Ser. No. 62/008,637, filed on Jun. 6, 2014, the entire disclosure of which is incorporated herein by reference.

### FIELD OF THE INVENTION

The present disclosure relates generally to an apparel supporting or holding device, such as a garter. The present disclosure also relates generally to a method of making the garter.

### BACKGROUND OF THE INVENTION

This section provides a general summary of background information and the comments and examples provided in this section are not necessarily prior art to the present disclosure.

Garters are articles of clothing that are often worn and fastened by women about a thigh area of their legs to support or hold up clothing such as stockings or socks. It is also a Western tradition for a bride to wear a garter to her wedding, which is to be removed toward the end of the wedding reception by the groom. The removed garter is then tossed to a group of unmarried male guests by the groom, with the man who catches the garter being obliged to place it on a leg of a woman guest who earlier caught the bride's bouquet. Since the garter is a focus of attention during the wedding reception, garters have been adorned with ribbons, bells, pins, embroideries and other decorations to add a personalized touch to the bride's attire. Garters are also provided with these decorations even when not used by brides because they can provide a personalized fashion aspect to a woman's wardrobe. Although these decorated garters do provide a personalized touch, they are not capable of producing lighted special effects.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of a garter disposed in an off condition;

FIG. 2 is a perspective view of the garter disposed in an on condition and illustrating a plurality of lights disposed along an outside or viewable portion of the lighted garter; and

FIG. 3 is a perspective view of the lighted garter including a portion shown in a cut-away view to more clearly illustrate a power source disposed along an inside portion of the body and interconnected to the plurality of lights disposed between an elastic band and a textile material of the garter.

### DETAILED DESCRIPTION OF THE ENABLING EMBODIMENTS

Example embodiments of a garter constructed in accordance with the present disclosure will now be more fully described. Each of these example embodiments are provided so that this disclosure is thorough and fully conveys the scope of the inventive concepts, features and advantages to those skilled in the art. To this end, numerous specific details are set forth such as examples of specific components, devices and mechanisms associated with the garter to provide a thorough understanding of each of the embodiments associated with the present disclosure. However, as will be apparent to those skilled in the art, not all specific details described herein need to be employed, the example embodiments may be embodied in many different forms, and thus should not be construed or interpreted to limit the scope of the disclosure.

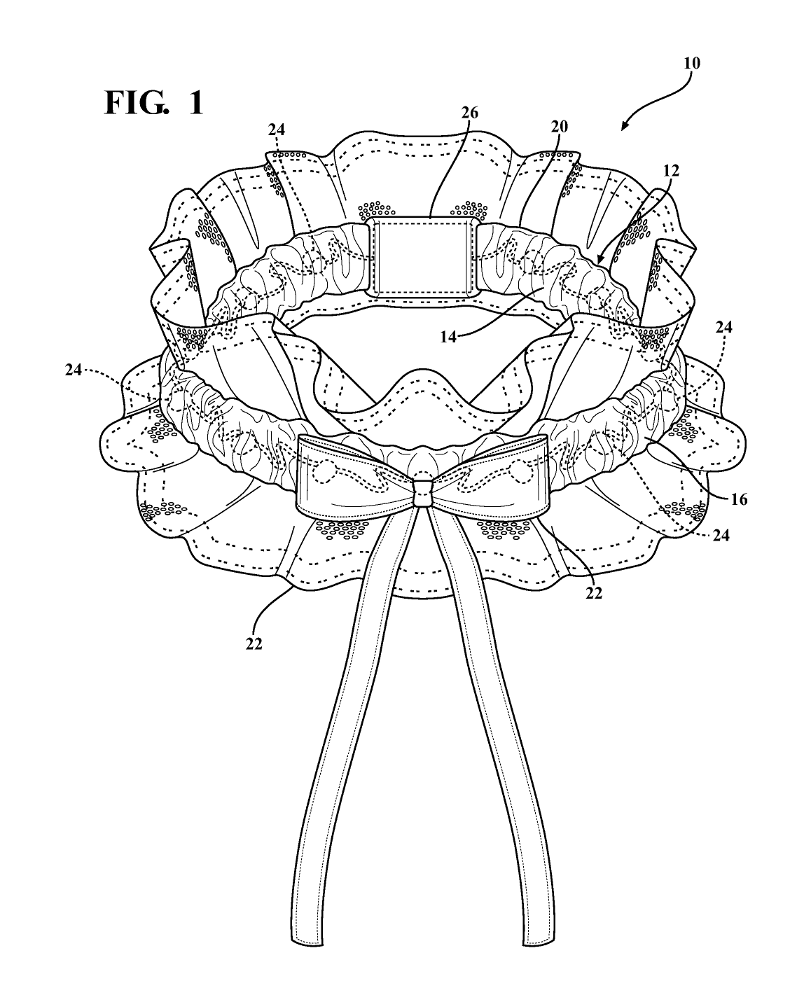

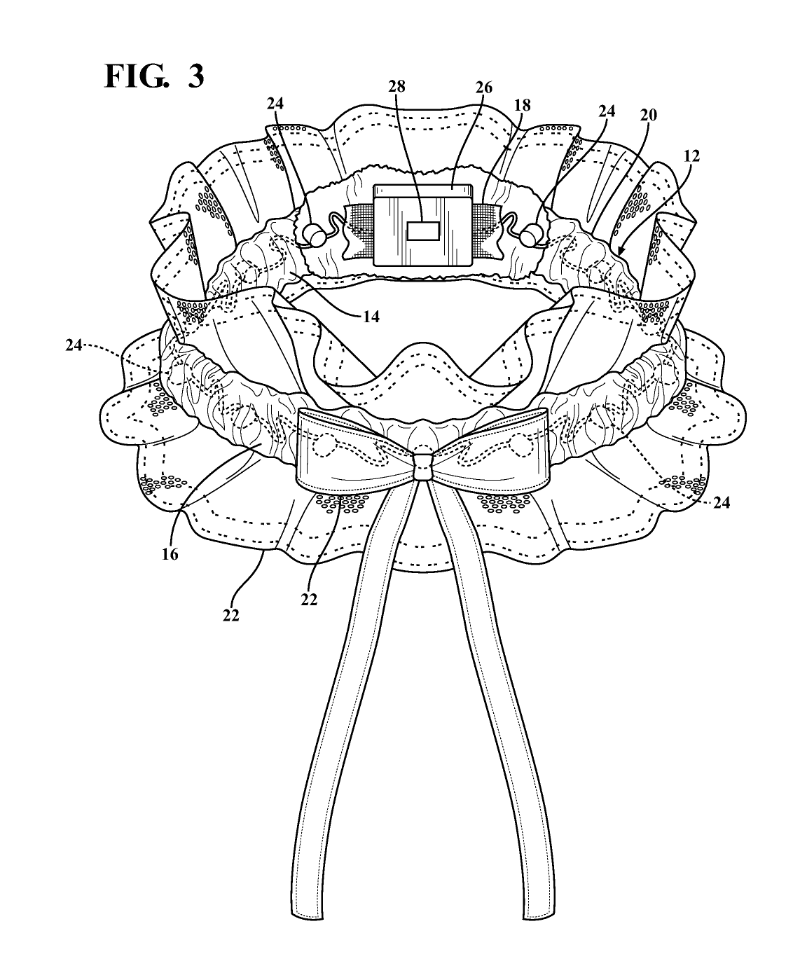

FIG. 1 is a perspective view of a garter 10 in an off condition. The garter preferably includes a body 12 having an inside portion 14 which is to be worn or disposed around a woman's leg and an outside portion 16 which is viewable by the woman or another person when worn on the woman's leg. As best shown in FIG. 3, the body 12 includes an elastic band 18 surrounded by a textile material 20, such as silk, cotton, polyester, or the like. The textile material 16 is bunched up around or loosely surrounds the elastic band 18 to provide a gap or pocket extending between the textile material 20 and the elastic band 18. At least one decoration 22, such as ribbons, silk patterns, bows, jewelry, or the like, extend from or are attached to the body 12 to decorate and provide personalized touches to the garter 10.

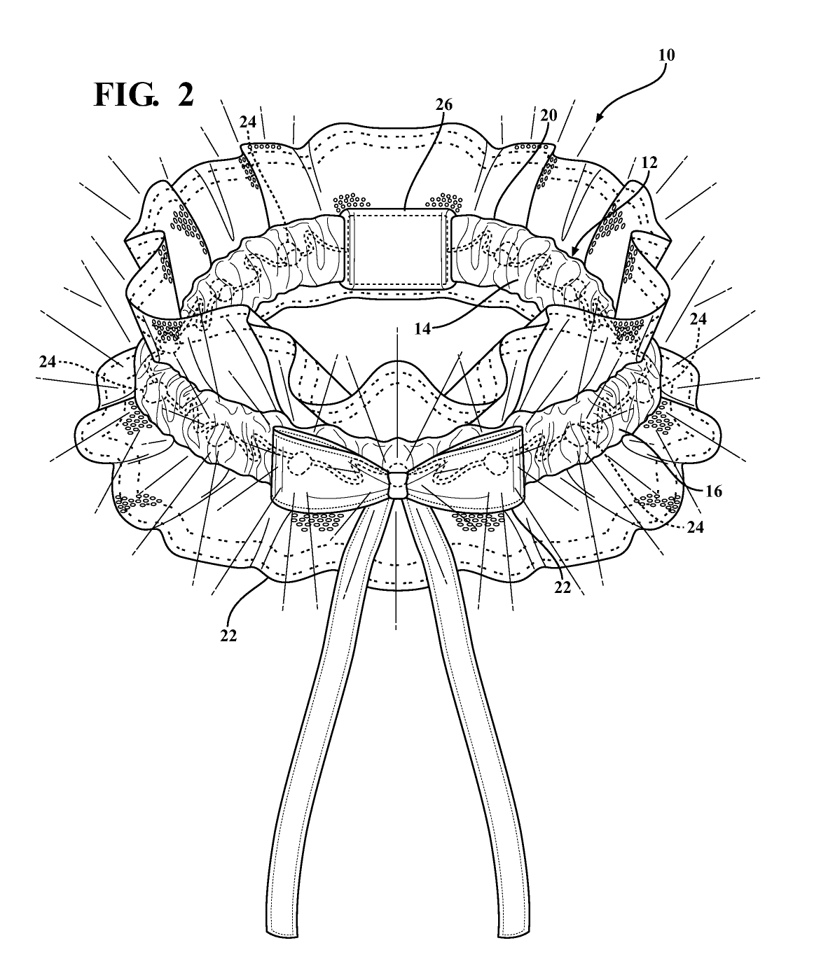

As best shown in FIGS. 1-3, the garter 10 includes a plurality of lights 24 electrically connected to one another and circumferentially disposed about the outside or viewable portion 16 of the body 12. In a preferred embodiment, the plurality of lights 24 are equidistantly spaced from one another to improve the visual effects of the plurality of lights 24 when they are placed in an on condition to light the garter 10. As best shown in FIG. 3, the plurality of lights 24 are disposed between the textile material 20 and the elastic band 18 within the gap or pocket. Put another way, the plurality of lights 24 are disposed within the body 12 of the garter 10. The plurality of lights 24 are electrically connected to a power source 26, such as a battery or the like, which is disposed along the inside portion 14 of the body 12 between the textile material 20 and the elastic band 18. The disposition of the plurality of lights 24 and the power source 22 within the body 12 and between the elastic band 18 and the textile material 20 hides these components from view when the garter 10 is placed in the off condition and no longer lit. As best shown in FIG. 3, the power source 26 includes a power switch 28 depressible by a user to turn on and off the power source 20 and switch or toggle the garter 10 between the off condition as illustrated in FIG. 1 and the on and lighted condition as illustrated in FIG. 2.

In a preferred arrangement, the plurality of lights 24 comprise light-emitting diode (LED) lights to provide the lighted garter 10 with lower energy consumption, longer lifetime, improved robustness and faster switching between the on and off conditions. In addition, since LED lights are cooler than incandescent, halogen, or compact fluorescent (CFL) light bulbs, the use of LED lights provide more comfort to a woman if the lighted garter 10 is worn around the thigh while in the on condition. The plurality of lights 24 can have a wide range of colors in the on condition, such as red, blue, white, yellow, or the like, and can even be programmed or adapted to individually change or switch between each of these various colors when the garter 10 is placed in the on or lighted condition. Additionally, the plurality of lights 24 can be programmed or adapted to flash at equal or variable time intervals. The plurality of lights 24 can also be programmed or adapted to flash or provide a strobe light effect, resulting in even further additional visual effects when the lighted garter 10 is used in a darker environment. The use of these various and interchangeable colors and flashing patterns for the plurality of LED lights 24 provides customized and personalized decorative touches to the lighted garter 10 not achievable by the prior art decorative garters.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A garter comprising:
a body including an elastic band surrounded by a textile material;
a plurality of lights electrically connected to one another and disposed about an outside portion of the body between said elastic band and said textile material; and
a power source disposed on said body and electrically connected to said plurality of lights to provide power to the plurality of lights and establish a lighted condition of the garter.

2. A garter as set forth in claim 1 wherein said plurality of lights comprise a plurality of light-emitting diode (LED) lights.

3. A garter as set forth in claim 1 wherein each of said plurality of lights is adapted to alternate between a plurality of colors during the lighted condition of the garter.

4. A garter as set forth in claim 1 where each of said plurality of lights is adapted to flash at a predetermined time interval during the lighted condition of the garter.

5. A garter as set forth in claim 4, wherein the predetermined time interval is a variable time interval.

6. A garter as set forth in claim 1, wherein each of the plurality of lights is adapted to provide a strobe light effect during the lighted condition of the garter.

7. A garter as set forth in claim 1, wherein said power source includes a power switch engagable by a user to turn on and off the power source and switch the garter between an off condition and the lighted condition.

8. An apparel supporting device comprising:
a body having an outside portion and including an elastic band surrounded by a textile material;
a plurality of lights electrically connected to one another and disposed about said outside portion of said body and between said elastic band and said textile material; and
a power source disposed on said body and electrically connected to said plurality of lights to provide power to the plurality of lights and establish an on and lighted condition of the apparel supporting device.

9. An apparel supporting device as set forth in claim 8 wherein said plurality of lights comprise a plurality of light-emitting diode (LED) lights.

10. An apparel supporting device as set forth in claim 8 wherein each of said plurality of lights is adapted to alternate between a plurality of colors during the on condition of the apparel supporting device.

11. An apparel supporting device as set forth in claim 8 where each of said plurality of lights is adapted to flash at a predetermined time interval during the on condition of the apparel supporting device.

12. An apparel supporting device as set forth in claim 11 wherein the predetermined time interval is a variable time interval.

13. An apparel supporting device as set forth in claim 8 wherein each of the plurality of lights is adapted to provide a strobe light effect during the on condition of the apparel supporting device.

14. An apparel supporting device as set forth in claim 8 wherein said power source includes a power switch engagable by a user to turn on and off the power source and switch the lighted garter between an off condition and the on condition.

15. A garter comprising:
a body having an inside portion and an outside portion and including an elastic band surrounded by a textile material;
at least one decoration extending from said body to decorate the garter;
a plurality of light-emitting diode (LED) lights electrically connected to one another and circumferentially disposed about said outside portion of said body between said elastic band and said textile material in equidistantly spaced relationship to one another;
a power source electrically connected to said plurality of lights and disposed along said inside portion of said body between said textile material and said elastic band; and
said power source including a power switch engagable by a user of the lighted garter to turn on said power source and switch the garter from an off condition to an on condition and allow each of said plurality of LED lights to flash between a plurality of colors at a predetermined time interval.
